(19) United States
(12) Patent Application Publication
(10) Pub. No.: US 2023/0228949 A1
(43) Pub. Date: Jul. 20, 2023

(54) SYSTEM AND METHOD FOR GUARANTEEING CORRECT POLARITY OF FIBER OPTIC CONNECTOR

(71) Applicant: US Conec Ltd., Hickory, NC (US)

(72) Inventors: Darrell R. Childers, Hickory, NC (US); Mike Elbert Hughes, Hickory, NC (US)

(21) Appl. No.: 18/001,603

(22) PCT Filed: Jun. 21, 2021
(86) PCT No.: PCT/US21/38191

§ 371 Date: Dec. 13, 2022

Related U.S. Application Data
(60) Provisional application No. 63/041,302, filed on Jun. 19, 2020.

(51) Int. Cl. G02B 6/38

(52) U.S. Cl. CPC G02B 6/3882; G02B 6/3825; G02B 6/3831

(57) ABSTRACT

Fiber optic assemblies are used to link transceivers carrying a signal from the transmitter portion of one transceiver to the receiver portion of another transceiver. The fiber optic assemblies have fiber optic connectors with a gender of either male or female. When the fiber optic connectors have fiber optic connectors with the same gender, the plurality of optical fibers are inverted and when the fiber optic assemblies have fiber optic connectors with an opposite gender, the plurality of optical fibers are not inverted. The inversion may also occur when the fiber optic connectors have the opposite gender in an alternative embodiment.

### REFERENCE TO RELATED CASE

This application claims priority under 35 U.S.C. § 119 (e) to U.S. provisional application No. 63/041,302 filed on Jun. 19, 2020, the contents of which are hereby incorporated by reference in their entirety.

### BACKGROUND OF THE INVENTION

Optical fibers in many data communication applications are routed between a transmitter-receiver pair. Typically, a transmitter (e.g., a laser or LED source) is co-located with a receiver (e.g., a photodiode) and this pair is jointly referred to as a transceiver. A transceiver on one side of an optical link is typically connected to another transceiver at a different point in the optical link. A working optical link has each transmitter (in a first transceiver) connected to a corresponding receiver (in a second transceiver) by optical fibers. The optical link will fail if the transmitter is accidentally or erroneously connected by the optical fibers to another transmitter (instead of to the receiver). Accordingly, it is important that a correct polarity (i.e., a transmitter connected to a receiver) is maintained between any two connection points in the optical link. These connection points may be two opposite end transceivers, or multiple transceivers (two or more) or transceivers with intermediary adapters. If there are multiple intermediary transceivers or connection points, then correct polarity has to be ensured throughout the optical link in that case as well.

Typically, fiber optic connectors are used to connect two or more optical fibers. When multi-fiber connectors (e.g., those having MT-ferrules) are utilized, tracking and maintaining polarity between two connection points is even more challenging. Certain industry standards such as the TIA-568 standard provides guidelines regarding polarity features and orientation of these connectors to ensure that a correct order of fibers is presented at every connection point to ensure that correct polarity is maintained. However, these connection schemes require extensive book-keeping at each connection point in the optical link by system implementers to make sure that the optical fiber(s) carrying a signal from the transmitter connects correctly to a receiver only. Further, certain conventional systems require that physical polarity features of a ferrule, or the connector housing, or both, be present and maintained in a particular relative orientation to ensure correct polarity. This is coupled with polarity features on adapters (“key-up to key-up” or “key-up to key-down”), which further complicates the setup. The challenge to ensure correct polarity is exacerbated when angle-polished ferrules are present, for example, in single mode fiber applications, further adding to the complexity in tracking polarity in optical fiber links since the ferrules can only be mated in one way. U.S. Pat. Nos. 7,184,635 and 7,147,383 provide examples of two conventional schemes for optical polarity.

For MPO type connectors, polarity errors may occur during assembly at the factory. Correct MPO polarity requires an end user to use the correct adapter for a given fiber optic assembly as well as requires the correct fiber optic assembly to be purchased by the end user. Further, in certain situations, the installer installing the MPO connectors into the adapters needs to verify the correct fiber optic assembly orientation with respect to the adapters. MPO polarity methods include both types of polarity cables (key-up to key-down, and key-up to key-up) in all gender and polish angle combinations (20 cable variants) with both adapter variants. These steps increase complexity, create end user confusion, and increase chances for error. Thus, there is a need for a method and system solution for addressing the problem of ensuring the correct polarity within an optical link, without having to resort to the aforementioned variations in connector and adapter assembly configurations and associated book-keeping complexities thereof.

### SUMMARY OF THE INVENTION

According to one aspect, the present invention is directed to a method for ensuring correct polarity in an optical link having a first transceiver and a second transceiver separated from one another that includes providing a first ferrule with guide pins and supporting optical fibers carrying optical signals passing through the first transceiver and a second ferrule with guide pins and supporting optical fibers carrying optical signals passing through the second transceiver, and providing at least one female-to-female jumper assembly having two female connectors couplable respectively to the first ferrule and the second ferrule via an adapter associated with the first transceiver and an adapter associated with the second transceiver, the at least one female-to-female jumper assembly having a plurality of optical fibers extending between the two female connectors, wherein said at least one female-to-female jumper assembly includes an inversion in an order of the plurality of optical fibers connecting the two female connectors, and wherein when the optical link is completed using at least one male-to-male trunk assembly having a plurality of optical fibers extending between two male connectors, the male-to-male trunk assembly having an inversion in an order of the plurality of optical fibers extending between the two male connectors, the number of inversions of optical fibers between the two adapters is an odd number.

In some embodiments, the optical link also includes an extender assembly having exactly one male connector and one female connector on opposing ends of a plurality of optical fibers, there being no inversion in an order of the optical fibers in the extender assembly.

In some embodiments, there is a key on each adapter is aligned to a key on one of connectors of the jumper assembly that directly mates in the adapter

In some embodiments, the optical link includes the at least one female-to-female jumper assembly and at least one male-to-male trunk assembly, the at least one male-to-male trunk assembly does not mate directly with either the first ferrule or the second ferrule.

In some embodiments, there also is an extender assembly having exactly one male connector and one female connector, the extender assembly being coupled to at least one of the first ferrule or the second ferrule.

In yet another aspect, there is a method for ensuring correct polarity in an optical link having a first transceiver and a second transceiver that includes providing a first ferrule with guide pins and supporting optical fibers carrying optical signals passing through the first transceiver, and a second ferrule with guide pins and supporting optical fibers carrying optical signals passing through the second transceiver, providing only three configurations of connector assemblies to maintain correct routing of optical signals between the first transceiver and the second transceiver, the three configurations of connector assemblies including: a jumper assembly having two female connectors on opposing ends of a plurality of optical fibers, a trunk assembly having two male connectors on opposing ends of a plurality of optical fibers, and an extender assembly having exactly one male connector and one female connector on opposing ends of a plurality of optical fibers, wherein routing of the optical signals is carried out using at least one jumper assembly couplable to the first ferrule and the second ferrule via respective adapters of the first and the second transceivers, the jumper assembly including an inversion in an order of the plurality of optical fibers, wherein when the optical link includes at least one trunk assembly, the trunk assembly including an inversion in an order of the plurality of optical fibers and wherein total number of inversions in optical fibers between the two adapters is odd, and wherein when the extender assembly is used in addition to the jumper assembly and/or the trunk assembly and there is no inversion in the order of the plurality of optical fibers in the extender assembly.

In yet another aspect, there is an optical system that includes a first adapter communicatively associated with a first transceiver, a second adapter communicatively associated with a second transceiver, the first and the second transceivers being optically coupled, a plurality of fiber optic assemblies, each of the plurality of optical fibers having opposing ends, the opposing ends being terminated by a first fiber optic connector and a second fiber optic connector, the fiber optic connectors having a gender of either male or female, and wherein when fiber optic connectors assemblies have fiber optic connectors with the same gender, the plurality of optical fibers are inverted and when the fiber optic connectors assemblies have fiber optic connectors with an opposite gender, the plurality of optical fibers are not inverted.

In yet another aspect, there is an optical system that includes a first adapter communicatively associated with a first transceiver, a second adapter communicatively associated with a second transceiver, the first and the second transceivers being optically coupled, a plurality of fiber optic assemblies, each of the plurality of optical fibers having opposing ends, the opposing ends being terminated by a first fiber optic connector and a second fiber optic connector, the fiber optic connectors having a gender of either male or female, and wherein when fiber optic connectors assemblies have fiber optic connectors with the same gender, the plurality of optical fibers are not inverted and when the fiber optic connectors assemblies have fiber optic connectors with an opposite gender, the plurality of optical fibers are inverted.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a perspective view of one embodiment of two fiber optic ferrules in a partially mated condition that are disposed within a fiber optic connector according to the present invention;

FIG. 2 is a front perspective view of two fiber optic connectors with one of the fiber optic ferrules of FIG. 1, one having a male configuration and one having a female configuration;

FIG. 3 is a perspective view of one embodiment of an optical link using one fiber optic assembly according to the present invention, the fiber optic assembly having two fiber optic connectors of FIG. 2 with the optical fibers inverted between the fiber optic connectors and schematic representations of transceivers having male-configured fiber optic connectors and adapters to receive a female configured fiber optic connector;

FIG. 4 illustrates three optical links and the methods of connecting two transceivers—one with three fiber optic assemblies with inverted optical fibers; one with two fiber optic assemblies without inverted optical fibers and one fiber optic assembly with inverted optical fibers; one with two fiber optic assemblies inverted optical fibers and one fiber optic assembly without inverted optical fibers that is inoperable;

FIG. 5 illustrates three optical links and methods of connecting two transceivers that are operable, each having an odd number of fiber optic assemblies with inverted optical fibers; and

FIG. 6 illustrates a second embodiment of fiber optic assemblies that have different gender configuration than in the first embodiment.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

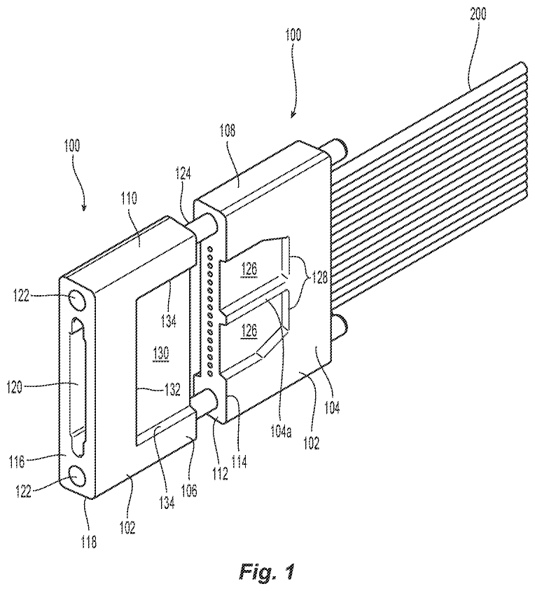

Illustrated in FIG. 1 are two multi-fiber ferrules 100 according to the present invention. Both of the multi-fiber ferrules 100 are the same, so the discussion of one applies equally to the other. The multi-fiber ferrule 100 has a main body 102 having a top portion 104 and a bottom portion 106. There is a first side portion 108 that extends between the top portion 104 and the bottom portion 106. There is also a second side portion 110 extending between the top portion 104 and the bottom portion 106 on opposites sides of the main body 102. The main body 102 also has an end face 112 at a front end 114 of the main body 102 and a rear face 116 at a rear end 118 of the main body 102. The multi-fiber ferrule 100 is significantly smaller than the conventional MT—ferrule and has typical dimensions of 1.25 mm height, 4 mm length (between the front end 114 and the rear end 118), and a width of 6.4 mm between the first side portion 108 and the second side portion 110.

The multi-fiber ferrule 100 has a rear central opening 120 extending into the main body 102 from the rear face 116 and configured to receive at least three optical fibers 200. The optical fibers 200 may be single mode or multi-mode, and may be single core or multi-core, or combinations thereof. Further, this disclosure is not limited by the size or diameter of the optical fibers 200. The multi-fiber ferrule 100 also has a plurality of fiber support structures to support the optical fibers (not shown). The fiber support structures are in communication with the rear central opening 120 and extending through the main body 102 to the end face 112. The main body 102 may also include two guide pin holes 122, which extend between the end face 112 and the rear face 116. The guide pin holes 122 provide a reference point with respect to the main body 102 and other structures to which the multi-fiber ferrule 100 is mated. As noted below, the guide pin holes 122 are outside the area of cutouts 126,130 to allow for enough material in the main body 102 to allow for the guide pin holes 122. The end face 112 may have a rectangular profile, although a trapezoidal profile (as shown) may also be provided as an alternative. There may be guide pins 124 that are disposed within the guide pin holes 122.

The top portion 104 has top cut-outs 126 that form first forward facing surfaces 128. The two top cut-outs 126 are separated by a continuation 104a of the top portion 104. The continuation 104a of the top portion 104 acts as a key for the multi-fiber ferrule 100. Alternatively, the continuation 104a may not be present, or may only be present partly extending rearward from the front end 114 and not forming a full partition between the two portions of the cutout 126.

The first forward facing surface 128 is used as a stop surface in conjunction with a housing for a connector, e.g., an SFP/QSFP footprint connector format. There may also be a number of other surfaces formed by the top cut-out 126. As illustrated in the figures, the top cut-outs 126 do not extend all of the way to the rear end 118, but stop short at the first forward facing surface 128. However, a portion of the top cut-out 126 could extend all the way to the back of the multi-fiber ferrule 100.

Similarly, the bottom portion 106 has the bottom cut-out 130 that forms a second forward facing surface 132. The second forward facing surface 132 is also used as a stop surface in conjunction with a housing for a connector. The bottom cut-out 130 also has two laterally facing surfaces 134 that form a portion thereof. The bottom cut-out 130 extends from the end face 112 towards the rear end 118, but does not reach the rear end 118. It may reach the same distance toward the rear end 118 from the end face 112 as does the top cut-out 126, but it may stop short of or beyond where the top cut-out 126 stops at forward facing surface 128. The cutouts 126,130 are dimensioned differently to allow for proper orientation of the mating multi-fiber ferrules 100, especially for angle-polished end faces 112, as further discussed below.

It should be noted that the thickness of the main body 102 varies across a width and a depth. The thickness of the main body 102 is least where the two cut-outs 126, 130 are located (i.e., having the least amount of multi-fiber ferrule 100 material). The thickness of the main body 102 is greatest where there are no cut-outs (i.e., having the most amount of multi-fiber ferrule 100 material).

Returning to the main body 102, there is no shoulder with multi-fiber ferrule 100 making the profile from the back to the front the same as the front to the back—and also the same at the end face 112 and the rear face 116. That is, the multi-fiber ferrule 100 is shoulder-less. There are also preferably no sharp edges along the length of the multi-fiber ferrule 100 at the junction of the side portions 108,110 to the top and bottom portions 104,106. It should also be noted that the top portion 104 may be wider than the bottom portion. That is, the distance across the top portion 104 may be greater than the distance across the bottom portion 106 between the side portions, in which case the end face 112 will have a trapezoidal profile.

The end face 112 is preferably angle-polished, i.e., at a non-pependicular angle relative to the rear face 116, and/or relative to the direction of propagation of the optical beam inside the optical fibers 100 in the multi-fiber ferrule 100. The end face 112 is angled at about 8° to a direction of propagation of the optical beam inside the optical fiber 200 held by the multi-fiber ferrule 100. However, other ranges may be utilized, such as 5°-15° or 4°-10°. Alternatively, the end-face 112 may be flat polished (i.e., perpendicular to the rear face 116 and to the beam propagation direction). The top cut-out 126 may have a different width than the bottom cut-out 130. This may also act as a polarity indication and/or may cause the ferrule 100 to be oriented in a specific direction when received inside a receptacle or an adapter for mating with another ferrule. Such different dimensions of the cutout 126 to the cutout 130 may render the continuation 104a redundant and unnecessary in some embodiments, and accordingly the continuation 104a may be eliminated. Alternatively, the top cut-out 126 may have a same width as the bottom cut-out 130.

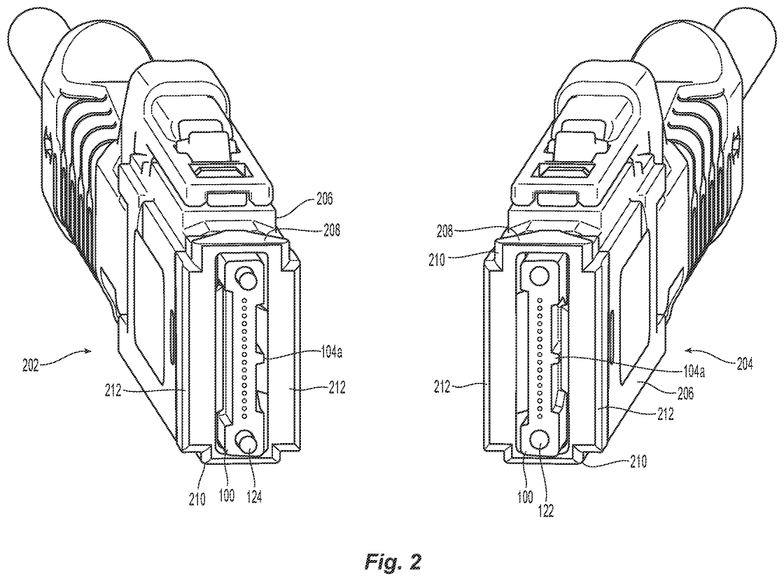

FIG. 2 illustrates two fiber optic connectors 202 and 204 that each includes a multi-fiber ferrule 100. The fiber optic ferrule 202 has guide pins 124 that are disposed within the guide pin holes 122. Thus, this fiber optic ferrule 202 has a male configuration. The fiber optic ferrule 204 does not have guide pins and therefore has a female configuration. The fiber optic connectors 202 and 204 are preferably the same and have the same components except for the guide pins 124. Thus, they will have an outer housing 206, which also has a key feature 208. The housing 206 has two short sides 210 and two long sides 212. The key feature 208 is preferably on one of the short sides 210, but could also be disposed on one of the long side 212. There are other internal components that are known to one of ordinary skill in the art and will not be discussed herein. However, one embodiment is discussed in PCT/US2021/028925, filed by the same applicant.

It should be noted that the multi-fiber ferrules 100 are installed in the outer housing 206 in the same orientation. The multi-fiber ferrules 100 may each protrude slightly from the front opening of the housing 206, as shown in FIG. 2, for example. That is the continuation 104a of the top portion 104 that acts as a key is in the same relationship to the keying feature 208 on the fiber optic connector 202,204. This means that the optical fibers 200 in each fiber optic connector 202,204 always have the same orientation with respect to both the outer housing 206 and the multi-fiber ferrules 100. Thus, even rotating the outer housing 206 and the multi-fiber ferrules 100 keeps the fiber order the same as before rotation. As noted below, the only difference in the fiber optic connectors 202,204 is the presence or absence of the guide pins 124 and whether the optical fibers 200 are inverted (flipped) with respect to the multi-fiber ferrules 100. In addition, the continuation 104a may be absent, in which case, the end face 112 has the same relative positioning to the keying feature 208 and/or the housing 206, in general. That is, the multi-fiber ferrule 100 has a fixed orientation relative to the outer housing 206 at all times regardless of the type of fiber optic assembly that it is a part of.

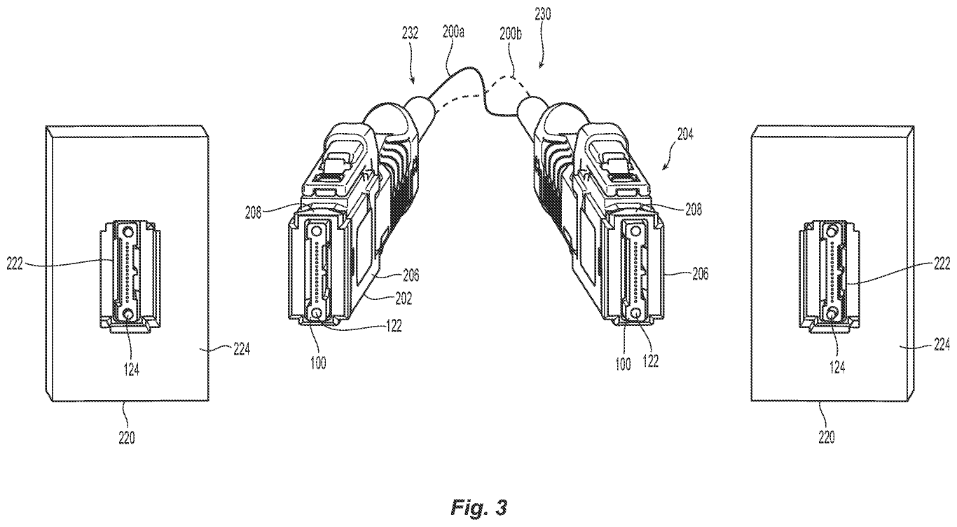

In FIGS. 3-6 there are representations of a transceiver 220 with a fiber optic connector 222 and an adapter 224. The fiber optic connector 222 associated with the transceiver 220 is preferably configured to have the male configuration (with guide pins 124). This male configuration setup of the fiber optic connector 222 is fixed inside the adapter 224, thereby eliminating another variable affecting polarity decisions in an optical link. Further, with the guide pins 124 already installed in the fiber optic connector 222, there are fewer pin stubbing issues with the mating of the fiber optic connectors 202,204 with the fiber optic connector 222. The fiber optic connectors 202,204 are to be connected to other fiber optic connectors 202,204 and to the fiber optic connector 222 through the adapter 224 associated with the transceiver 220. In the present invention, it is preferred that the transceiver signals are always in a fixed location with respect to the order of the optical fibers in the fiber optic connector 222. Generally, the transmitter side optical fibers 200 are towards a top side of the multi-fiber ferrules 100 in the fiber optic connector 222, e.g., fibers 1-8, and the receiver side fibers 200 are towards a bottom side of the multi-fiber ferrules 100, e.g., fibers 9-16 for a 16-fiber ferrule. This matches up with the type of adapter 224 used for interfacing to the transceiver signals immediately as they exit or enter the transceiver 220 module. That is, the adapter 224 at the transceiver 220 is the same for all transceivers in the optical link. The adapter interface 224 is shaped to accept a corresponding outer connector housing 206 in a key-up to key-up manner only. See FIG. 3 where the keying feature 208 is up. This allows for the system to always have the same adapter configuration, just as the system has the same configuration of the multi-fiber ferrules 100 (except for the guide pins as noted above). Alternatively, the system could be altered to always be in a key-down to key-down configuration.

Further with regard to FIG. 3, there is illustrated a fiber optic assembly 230. Generally, a fiber optic assembly 230 has two fiber optic connectors (e.g., fiber optic connectors 202,204) with the multi-fiber ferrules 100 and optically connected by optical fibers 200. The present invention has exactly three types of these fiber optic assemblies 230 to eliminate the complexities associated with polarity decisions in such optical links (as opposed to up to 20 variations possible in conventional links). First, illustrated in FIG. 3 is a jumper assembly 232 (female-to-female jumper assembly) that has two fiber optic connectors 204 with a female configuration. It also has the optical fibers 200 inverted as illustrated by the solid line and the broken line (the first and the sixteenth optical fibers are shown with the other 14 removed for clarity). Thus, the optical fiber 200a on the top in the left fiber optic connector 202 is routed to the bottom in the right fiber optic connector 202, and the optical fiber 200b on the bottom in the left fiber optic connector 202 is routed to the top in the right fiber optic connector 202. Naturally, all of the optical fibers 200 are thus routed (optical fiber in place 15 is routed to place 2, etc.) Thus, the order of fibers between the left and right connectors 202,204 in the jumper assembly 232 is inverted or flipped. One of ordinary skill in the art after reading this disclosure will appreciate that if such a flip were not present in FIG. 3, it would lead to an inoperable optical link between the two transceivers 220 since the transmitter portion from one would go to the transmitter portion of the other (and same for the receiver portion).

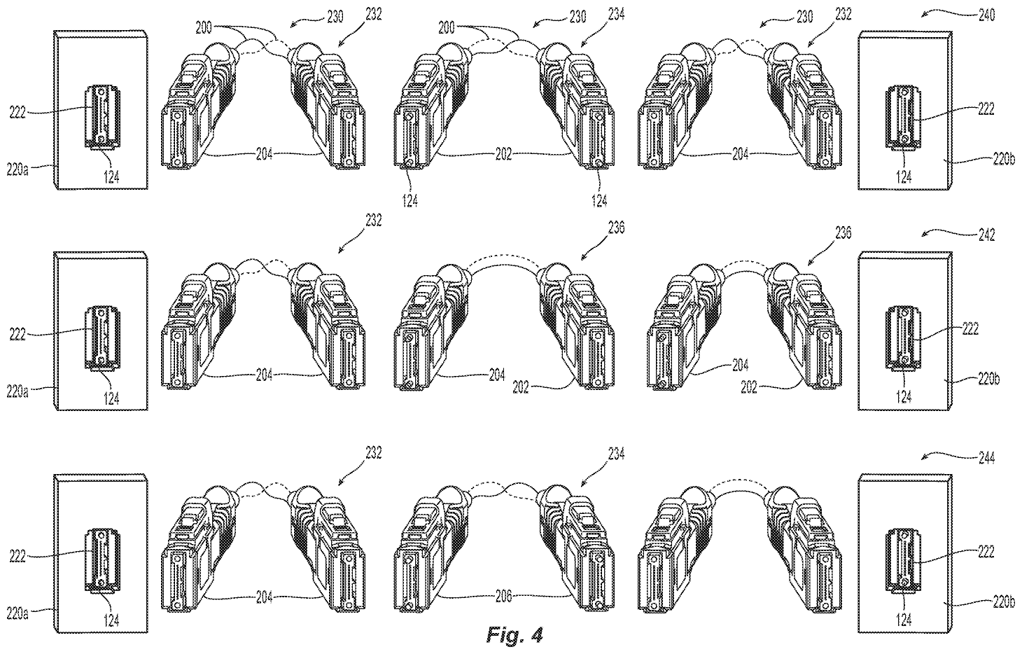

The present invention also uses a fiber optic assembly 230 that has two male configured fiber optic connectors and is referred to herein as a trunk assembly (male-to-male trunk assembly) 234. It is the same as jumper assembly 232 but with guide pins 124 in the multi-fiber ferrule 100. See, e.g., the fiber optic assembly 230 in FIG. 4 at the top row in the middle (guide pins 124 are present in both connectors 202). As with the jumper assembly 232, the trunk assembly 234 also has the optical fibers 200 inverted (flipped) as illustrated by the solid line and the broken line. The trunk assembly 230 is the second type of fiber optic assembly 230 in accordance with this disclosure.

Finally, the present invention also uses a fiber optic assembly 230 that has one female-configured fiber optic connector 204 and one male-configured fiber optic connector 202 and is referred to herein as a extender assembly (male-to-female trunk assembly) 236. See, e.g., the fiber optic assembly 230 in FIG. 4 at the second and third positions in the middle row viewing from the left to the right of the figure. As the term “extender” suggests, the extender assembly 236 simply extends or continues the polarity order of fibers between any two points in the optical link. That is, in this extender assembly 236, the optical fibers are not inverted (flipped) but pass light directly through.

There needs to be at least one inversion (or flipping) in the order of the optical fibers in the overall optical link in order for the signals to be properly transmitted between the transceivers 220 through the optical fibers 200 in the fiber optic assemblies 230. This is because with the transceivers 220 always having the transmission portion on top and the receiving portion on the bottom of the connectors 222, the optical fibers 200 need to be inverted to allow the signals from the upper transmission portion in one transceiver 220 to be received by the lower receiving portion of another transceiver 220. As will be understood, since there needs to be one inversion to have a correct optical connection, there could be any number of inversions, as long as that number is odd (i.e., 1, 3, 5, 7, etc.). If it were to be an even number of fiber order inversions (and a pass through of the signals), then the transmission portions of the two transceivers 220 would be trying to communicate with each other, causing the optical link to fail.

Using these components, an optical link can be constructed with fewer components and information than with the prior art systems. Three such examples of optical links 240, 242 and 244 are illustrated in FIG. 4. The first optical link 240 has a first transceiver 220a and a second transceiver 220b. Disposed between these two transceivers 220a, 220b are three fiber optic assemblies 230—two jumper assembles 232 that would be attached to the transceivers 220a, 220b by way of the female-configured fiber optic connectors 204 with a trunk assembly 234 connected therebetween. The (female-to-female) jumper assemblies 232 are connected to the male-configured fiber optic connectors 222 in the transceivers 220 and then the trunk assembly (male-to-male trunk assembly) 234 is used to connect the two jumper assembles 232 to one another. In this optical link 240 there are three inversions in the order of the optical fibers, one for each of the fiber optic assemblies 230 that are positioned between the two transceivers 220.

The second optical link 242 also has a first transceiver 220a and a second transceiver 220b. Disposed between these two transceivers 220a,220b are three fiber optic assemblies 230—one jumper assembly 232 and two extender assemblies 236. Since the extender assemblies 236 have one male and one female connector, they can connect the jumper assembly 232 to the second transceiver 220b, the first transceiver 220a connecting to the jumper assembly 232 directly. Again, in this optical link, there is one inversion of the optical fibers—in the jumper assembly 232, and no inversion for the extender assemblies 236. Thus, an odd number of inversions of fibers exist in this optical link.

The third optical link 244 is one that is inoperable as it has two inversions, an even number and not an odd number. The optical link 244 has one jumper assembly 232 connected to a trunk assembly (male-to-male trunk assembly) 234. The second transceiver 220b is connected to a pass through fiber optic assembly 230 that has no fiber order inversions, providing two total inversions from the jumper assembly 232 and the trunk assembly 234. This configuration will not work since the inversion in the jumper assembly 232 is undone by the inversion in the trunk assembly 234 (leading to the transmitter of one transceiver 220 being connected with the transmitter of the other transceiver 220).

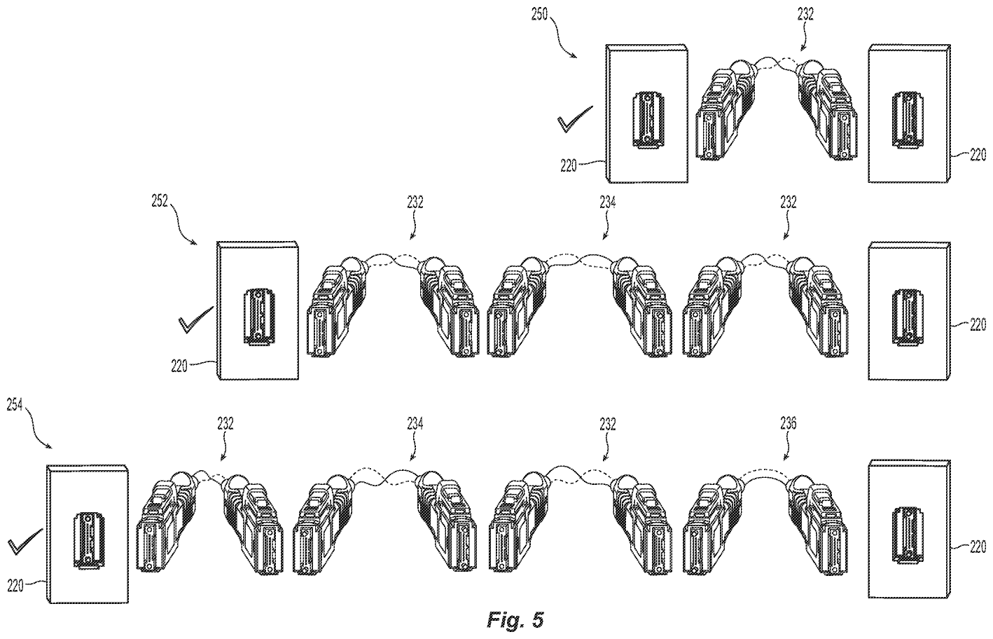

FIG. 5 illustrates three more optical links 250, 252, and 254. As with the optical links in FIG. 4, there are two transceivers 220 to be connected. In optical link 250 there is a single jumper assembly 232. It should be noted that the lengths of the optical fibers 200 could be of any appropriate length, depending on the installation and usage.

The second optical link 252 has two jumper assemblies 232 on either side of a trunk assembly 234. In this case, there are three inversions, one for each of the fiber optic assemblies.

The third optical link 254 has two jumper assemblies 232 on either side of a trunk assembly 234 and then an extender assembly 236 connected to the second jumper assembly 232. The first three fiber optic assemblies 230 have inversions (three is an odd number) and the extender assembly 236 is a pass-through.

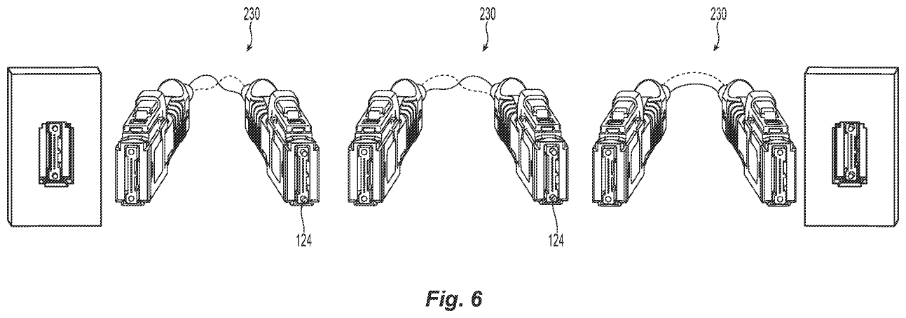

A keen eye will note that the fiber optic assemblies 230 with the same gender configuration (all male or all female) of the fiber optic connectors also have the optical fibers inverted or flipped. The extender assembly 236, having different gender configurations, have a pass through with no flipping/inversion in the order of optical fibers between the individual connectors making up the extender assembly 236. Thus, as long as there are an odd number of those fiber optic assemblies 230 with the same gender, then the optical link will work. Alternatively, the fiber optic assemblies 230 with the different gender configurations of the fiber optic connectors could have the optical fibers inverted or flipped and the same gender fiber optic connectors could be the pass throughs. Again, as long as there is an odd number of inversions or flips, the optical link would work. This is illustrated in FIG. 6, where the first two fiber optic assemblies 230 have different gender fiber optic connectors (guide pins 124 are noted) and have the optical fibers inverted, while the last fiber optic assembly has the same gender connectors (female) and it does not have an inversion or flipping of the optical fibers 200. The connection setups described herein can be modified to have the fiber optic connector 222 in the transceivers 220 is chosen to be fixed as a female-type connector 204 (although this modification may not be preferable). In that setup, the positions of the jumper assembly 232 will be taken up by the trunk assembly(ies) 234 and vice-versa, to still have a guaranteed correct polarity configuration with only three types of fiber optic assemblies 230. In this alternative setup, the extender assembly 236 will still have the same configuration as above.

Due to the configuration of the three jumper types, the user is guaranteed to have an odd number of inversions by using the gender of the connector as a guide. For example, assuming the first transceiver is male, we know we need a female connector to plug in. We could select either the female end of an extender or a female jumper and plug into the first transceiver. Since we are assuming that all transceivers are the same, the second transceiver would also be male and we would need a female connector to end the link. If the user continues to use the gender of the mating connector as a guide, the user can take any combination of jumpers, trunks, and extenders and as long as the connectors pairs mate with one male and one female connector, there will always be an odd number of inversions in the link. Although the design shown allows the user to attempt to mate female and female connectors or male to male connectors, adapters could be designed to prevent mating of similar gender connectors, further preventing polarity concerns in the link.

Although the invention here focuses on a multi-fiber ferrule, the same convention could apply to duplex connectors with single fiber ferrules as well. Since single fiber ferrule connectors normally utilize 1.25 mm ceramic ferrules and do not utilize guide pins or gender, the connector would have a gender or type associated with it. For example, the connector could have a key that represented male or female type or the connector could have a “plug” type and a “jack” type. Fiber optic assemblies that have connector types on ends that are opposite one another would not have a fiber inversion, i.e., a plug-jack jumper. Fiber optic assemblies with the same type of connectors would have a fiber inversion, i.e., a plug-plug or a jack-jack assembly. Regardless of the type of fiber optic assembly, in duplex connector assemblies according to this embodiment, the individual single-fiber ferrules would be fixed relative to the rest of the connector (e.g., the housing 206). Instead of the gender (male/female) being used as a variable to assemble exactly three types of fiber optic assemblies in the aforementioned embodiments (i.e., jumpers, trunks, and extenders), the key associated with the individual connector and ferrules would classify the fiber optic assemblies as being one of the three types, namely, a plug-plug assembly, a jack-jack assembly, and a plug jack assembly, in this embodiment. Thus, even in the scenario when duplex connectors are used, the overall polarity decisions are significantly simplified by providing exactly three types of fiber optic assemblies, and by eliminating other variables in the optical link that affect polarity decisions in a conventional setup.

There also is an optical system that includes a first adapter communicatively associated with a first transceiver (e.g., the transceiver 220a), and a second adapter communicatively associated with a second transceiver (e.g., the transceiver 220b). The first and the second transceivers are optically coupled. The optical system includes a plurality of fiber optic assemblies, each of the plurality of optical fibers having opposing ends, the opposing ends being terminated by a first fiber optic connector and a second fiber optic connector, the fiber optic connectors having a gender of either male or female. When fiber optic assemblies have fiber optic connectors with the same gender, the plurality of optical fibers are not inverted and when the fiber optic assemblies have fiber optic connectors with an opposite gender, the plurality of optical fibers are inverted.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A method for ensuring correct polarity in an optical link having a first transceiver and a second transceiver separated from one another, comprising:
providing a first ferrule with guide pins and supporting optical fibers carrying optical signals passing through the first transceiver and a second ferrule with guide pins and supporting optical fibers carrying optical signals passing through the second transceiver; and
providing at least one female-to-female jumper assembly having two female connectors couplable respectively to the first ferrule and the second ferrule via an adapter associated with the first transceiver and an adapter associated with the second transceiver, the at least one female-to-female jumper assembly having a plurality of optical fibers extending between the two female connectors,
wherein said at least one female-to-female jumper assembly includes an inversion in an order of the plurality of optical fibers connecting the two female connectors, and
wherein when the optical link is completed using at least one male-to-male trunk assembly having a plurality of optical fibers extending between two male connectors, the male-to-male trunk assembly having an inversion in an order of the plurality of optical fibers extending between the two male connectors, the number of inversions of optical fibers between the two adapters is an odd number.

2. The method according to claim 1, wherein the optical link also includes an extender assembly having exactly one male connector and one female connector on opposing ends of a plurality of optical fibers, there being no inversion in an order of the optical fibers in the extender assembly.

3. The method according to claim 1, further comprising a key on each adapter is aligned to a key on one of connectors of the jumper assembly that directly mates in the adapter.

4. The method according to claim 3, wherein the key on one of the connectors is on a short side of the connector.

5. The method according to claim 1, wherein the optical link includes the at least one female-to-female jumper assembly and at least one male-to-male trunk assembly, the at least one male-to-male trunk assembly does not mate directly with either the first ferrule or the second ferrule.

6. The method according to claim 1, further comprising an extender assembly having exactly one male connector and one female connector, the extender assembly being coupled to at least one of the first ferrule or the second ferrule.

7. The method according to claim 1, wherein the fiber optic ferrules all have a non-perpendicular angled end face relative to a direction of mating/optical beam propagation.

8. The method according to claim 1, wherein between the first transceiver and the second transceiver, any two mating ferrules have end faces that are mated in opposing end face orientations.

9. A method for ensuring correct polarity in an optical link having a first transceiver and a second transceiver, comprising:
providing a first ferrule with guide pins and supporting optical fibers carrying optical signals passing through the first transceiver, and a second ferrule with guide pins and supporting optical fibers carrying optical signals passing through the second transceiver; and
providing only three configurations of connector assemblies to maintain correct routing of optical signals between the first transceiver and the second transceiver, the three configurations of connector assemblies including: a jumper assembly having two female connectors on opposing ends of a plurality of optical fibers, a trunk assembly having two male connectors on opposing ends of a plurality of optical fibers, and an extender assembly having exactly one male connector and one female connector on opposing ends of a plurality of optical fibers,
wherein routing of the optical signals is carried out using at least one jumper assembly couplable to the first ferrule and the second ferrule via respective adapters of the first and the second transceivers, the jumper assembly including an inversion in an order of the plurality of optical fibers,
wherein when the optical link includes at least one trunk assembly, the trunk assembly including an inversion in an order of the plurality of optical fibers and wherein total number of inversions in optical fibers between the two adapters is odd; and
wherein when the extender assembly is used in addition to the jumper assembly and/or the trunk assembly and there is no inversion in the order of the plurality of optical fibers in the extender assembly.

10. The method according to claim 9, further comprising a key on each adapter is aligned to a key on one of connectors of the jumper assembly that directly mates in the adapter.

11. The method according to claim 9, wherein the optical link includes the at least one female-to-female jumper assembly and at least one male-to-male trunk assembly, the at least one male-to-male trunk assembly does not mate directly with either the first ferrule or the second ferrule.

12. The method according to claim 9, further comprising an extender assembly having exactly one male connector and one female connector, the extender assembly being coupled to at least one of the first ferrule or the second ferrule.

13. The method according to claim 9, wherein the fiber optic ferrules all have non-perpendicular angled end face relative to a direction of mating/optical beam propagation.

14. An optical system, comprising:
a first adapter communicatively associated with a first transceiver;
a second adapter communicatively associated with a second transceiver, the first transceiver and the second transceiver being physically separated and optically coupled;
a first ferrule with guide pins inside the first adapter and having optical fibers carrying optical signals passing through the first transceiver;
a second ferrule with guide pins inside the second adapter and supporting optical fibers carrying optical signals passing through the second transceiver; and
at least one jumper assembly having two female connectors at opposing ends of a plurality of optical fibers, a first of the two female connectors coupling to the first ferrule via the first adapter, and a second of the two female connectors capable of coupling to the second ferrule via the second adapter,
wherein said jumper assembly includes an inversion in an order of the plurality of optical fibers connecting the two female connectors, the first transceiver and second transceiver and the at least one jumper assembly forming an optical link, and
wherein when the optical link includes at least one male-to-male trunk assembly having two male connectors on opposing ends of a plurality of optical fibers and between said first and second transceivers, a total number of inversions of optical fibers between the two adapters is odd.

15. An optical system, comprising:
a first adapter communicatively associated with a first transceiver;
a second adapter communicatively associated with a second transceiver, the first and the second transceivers being optically coupled; and
a plurality of fiber optic assemblies, each of the plurality of optical fibers having opposing ends, the opposing ends being terminated by a first fiber optic connector and a second fiber optic connector, the fiber optic connectors having a gender of either male or female, and wherein when fiber optic assemblies have fiber optic connectors with the same gender, the plurality of optical fibers are inverted and when the fiber optic assemblies have fiber optic connectors with an opposite gender, the plurality of optical fibers are not inverted.
